(19) United States
(12) Patent Application Publication
(10) Pub. No.: US 2020/0244524 A1
(43) Pub. Date: Jul. 30, 2020

(54) NETWORK DEVICE MONITORS

(71) Applicant: Hewlett Packard Enterprise Development LP, Houston, TX (US)

(72) Inventor: Eric Lee Fritsch, Fort Collins, CO (US)

(21) Appl. No.: 16/260,441

(22) Filed: Jan. 29, 2019

(51) Int. Cl. H04L 12/24; H04L 12/26; H04L 29/12

(52) U.S. Cl. CPC H04L 41/0816; H04L 43/04; H04L 61/6022; H04L 41/0866; H04L 61/1511; H04L 41/0853

(57) ABSTRACT

An example monitor device can include a memory resource storing instructions executable by a processing resource to: capture configuration data for a plurality of network devices of a network, establish a connection with the plurality of network devices utilizing the captured configuration data, capture log data from the plurality of network device through the established connection, and generate an event table for the network based on the captured log data.

### BACKGROUND

A network, also referred to as a computer network or a data network, is a digital telecommunications network which allows nodes (e.g., computing devices, network devices, etc.) to share resources. In networks, nodes exchange data with each other using connections (e.g., data links) between nodes. These connections can be established over cable media such as wires or optic cables, or wireless media such as a wireless local area network (WLAN).

### BRIEF DESCRIPTION OF THE DRAWINGS

FIG. 1 is an example system for network device monitors consistent with the present disclosure.

FIG. 2 is an example monitor device for network device monitors including a processing resource and a memory resource consistent with the present disclosure.

FIG. 3 is an example memory resource for network device monitors including instructions executable by a processing resource consistent with the present disclosure.

FIG. 4 is an example system for network device monitors consistent with the present disclosure.

FIG. 5 is an example flow diagram for network device monitors consistent with the present disclosure.

### DETAILED DESCRIPTION

Network devices can be utilized to connect computing devices over a network. As used herein, a network device can, for example, include a physical device utilized for communication and/or interaction between computing devices. For example, network devices can include, but are not limited to: routers, gateways, network bridges, modems, switches, among other devices utilized to provide a communication channel between computing devices.

In some examples, network devices can generate log data when an event occurs on the network devices. As used herein, log data can, for example, include a record file of an event that describes features of the event. For example, log data can include a digital record of the event that can include features such as, but not limited to: an event type, a time of the event, a port where the event occurred, among other features of the event. In some examples, the log data can be stored on the network device. For example, the log data can be stored in a memory resource on the network device (e.g., cache memory resource, etc.).

Some networks can utilize network devices with different properties or capabilities. For examples, networks can utilize network devices from different manufacturers, network devices with different hardware and/or firmware, network devices of different types, and/or network devices with different types of log data. It can be difficult to with these types of networks to monitor and control the different types of network devices.

Examples of the present disclosure provide for monitor devices for monitoring and/or controlling a plurality of different network devices. For instance, an example monitor device can include a memory resource storing instructions executable by a processing resource to: capture configuration data for a plurality of network devices of a network, establish a connection with the plurality of network devices utilizing the captured configuration data, capture log data from the plurality of network device through the established connection, and generate an event table for the network based on the captured log data. In this way, the monitor device can capture configuration data for a plurality of different types of network devices such that the monitor device can establish the connection to capture log data from the plurality of different types of network devices and instruct the plurality of network devices to send the log data to a database for storage and analysis.

Some examples of the present disclosure can provide a flexible monitoring system for a network that can allow custom script integration and/or templates to be utilized for analyzing the collected log data. In addition, the present disclosure can provide a monitoring system for networks that utilize a plurality of network devices that utilize different hardware and/or firmware.

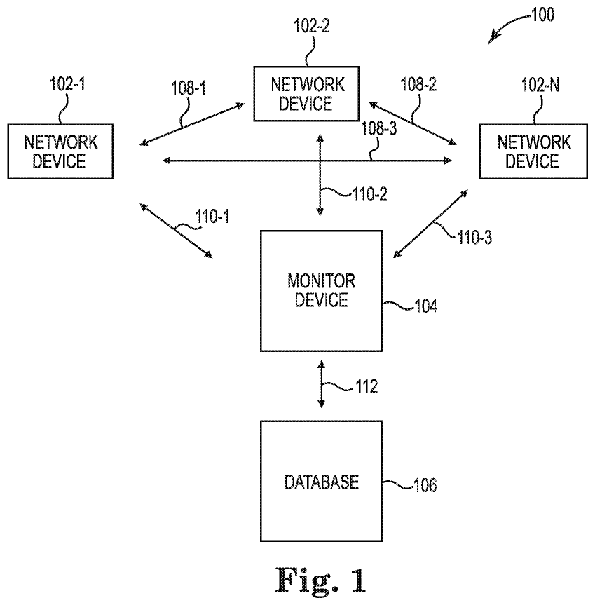

FIG. 1 is an example system 100 for network device monitors consistent with the present disclosure. In some examples, the system 100 can be a network that can be utilized to provide a communication channel between computing devices. In some examples, the system 100 can include a plurality of network devices 102-1, 102-2, 102-N. In some examples, the plurality of network devices 102-1, 102-2, 102-N can include communication channels 108-1, 108-2, 108-3 to send and receive messages (e.g., data packets, etc.) between the plurality of network devices 102-1, 102-2, 102-N and/or other computing devices coupled to the system 100. As used herein, the communication channels 108-1, 108-2, 108-3 can, for example, include wired or wireless connections to allow messages or data packets to be sent and/or received.

In some examples, the plurality of network devices 102-1, 102-2, 102-N can include different types of network devices that have different manufacturers, different types of hardware, and/or different types of firmware. Thus, in some examples, the plurality of network devices 102-1, 102-2, 102-N can utilize different systems for generating log data and/or storing the generated log data. In these examples, the plurality of network devices 102-1, 102-2, 102-N can store the generated log data locally in a memory resource on the corresponding network device. For example, the network device 102-1 can be manufactured by a first manufacturer and the network device 102-2 can be manufactured by a second manufacturer that is different than the first manufacturer. In this example, the different network devices 102-1, 102-2, 102-N can have different settings and/or configuration data.

In some examples, the system 100 can include a monitor device 104. The monitor device 104 can be a computing device that is communicatively coupled to the system 100. For example, the monitor device 104 can include a processing resource, a memory resource that stores instructions, and/or a network device to allow the monitor device 104 to communicate with the plurality of network devices 102-1, 102-2, 102-N. In some examples, the monitor device 104 can establish a communication channel 110-1, 110-2, 110-3 or communication connection with each of the plurality of network devices 102-1, 102-2, 102-N. In some examples, the monitor device 104 can be utilized to capture configuration data from the plurality of network devices 102-1, 102-2, 102-N and utilize the communication channels 110-1, 110-2, 110-3 to establish a connection with the plurality of network devices 102-1, 102-2, 102-N. As used herein, the configuration data can include a domain name system (DNS) name for the plurality of network devices 102-1, 102-2, 102-N, a model for the plurality of network devices 102-1, 102-2, 102-N, a firmware for the plurality of network devices 102-1, 102-2, 102-N, and/or credentials for the plurality of network devices 102-1, 102-2, 102-N.

As described further, herein, the monitor device 104 can utilize the established connection with the plurality of network devices 102-1, 102-2, 102-N to capture log data from the plurality of network devices 102-1, 102-2, 102-N and/or instruct the plurality of network devices 102-1, 102-2, 102-N to transmit the corresponding log data to a database 106. In some examples, the monitor device 104 can be communicatively coupled to the database 106 through a communication channel 112. In some examples, the database 106 can include a memory resource to store the log data from the plurality of network devices 102-1, 102-2, 102-N. In some examples, the monitor device 104 can generate an event table within the database 106 from the log data provided to the database 106 from the plurality of network devices 102-1, 102-2, 102-N.

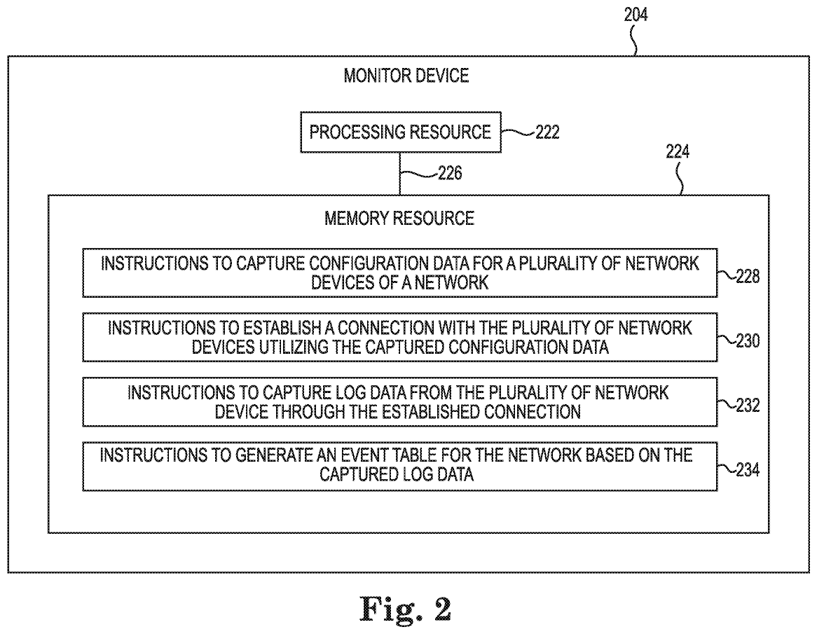

FIG. 2 is an example monitor device 204 for network device monitors including a processing resource 222 and a memory resource 224 consistent with the present disclosure. A monitor device 204, as used herein includes a device (e.g., physical device) used for communication and interaction between network devices on a computer network. Network devices can mediate data in a computer network. Example network devices include switching devices (also known as “switches”), routers, router/switching device combinations, models, access points, gateways, networking cables, network interface controllers, and hubs, among others. In some instances, monitor device 204 can be or include a controller. Monitor device 204 can be a combination of hardware and instructions for network device monitoring. The hardware, for example can include processing resource 222 and/or a memory resource 224 (e.g., MRM, computer-readable medium (CRM), data store, etc.).

Processing resource 222, as used herein, can include a number of processing resources capable of executing instructions stored by a memory resource 224. The instructions (e.g., machine-readable instructions (MRI)) can include instructions stored on the memory resource 224 and executable by the processing resource 222 to implement a desired function (e.g., network device monitoring). The memory resource 224, as used herein, can include a number of memory components capable of storing non-transitory instructions that can be executed by processing resource 222. Memory resource 224 can be integrated in a single device or distributed across multiple devices. Further, memory resource 224 can be fully or partially integrated in the same device as processing resource 222 or it can be separate but accessible to that device and processing resource 222. Thus, it is noted that the monitor device 204 can be implemented on an electronic device and/or a collection of electronic devices, among other possibilities.

The memory resource 224 can be in communication with the processing resource 222 via a communication link 226 (e.g., path). The communication link 226 can be local or remote to an electronic device associated with the processing resource 222. The memory resource 222 includes instructions 228, 230, 232, 234. The memory resource 224 can include more or fewer instructions than illustrated to perform the various functions described herein. In some examples, instructions (e.g., software, firmware, etc.) 228, 230, 232, 234 can be downloaded and stored in memory resource 224 (e.g., MRM) as well as a hard-wired program (e.g., logic), among other possibilities.

Instructions 228, when executed by a processing resource such as processing resource 222 can capture configuration data for a plurality of network devices of a network. As used herein, configuration data can, for example, include data that includes information about a system configuration of a particular device. In some examples, the configuration data includes a domain name system (DNS) name for the plurality of network devices, a model for the plurality of network devices, a firmware for the plurality of network devices, and credentials for the plurality of network devices. The system configuration can define the capabilities and/or features of the device such as, but not limited to: processing resource capabilities, memory capabilities, firmware, login information, physical and/or virtual connections, among other capabilities or features of the device.

In some examples, the configuration data from the plurality of network devices can be utilized by the monitor device 204 to determine different attributes and/or settings of each of the plurality of network devices. In some examples, the configuration data can be requested by the monitor device 204 and in response to the request, the plurality of network devices can provide corresponding configuration data to the monitor device 204. In some examples, the configuration data can include a media access control (MAC) address for each of the plurality of network devices of the network. In some examples, the MAC address for a network device can be a unique identifier for the network device within the network. In this way, the monitor device 204 can identify specific network devices within the network.

In some examples, the monitor device 204 can analyze the configuration data for the plurality of network devices to identify a process for establishing a connection with each of the plurality of network devices and/or identify a process for altering settings of each of the plurality of network devices. For example, the monitor device 204 can utilize the configuration data from each of the plurality of network devices to access information such as login information. In this example, the monitor device 204 can utilize the access information to establish a connection with each of the plurality of network devices even when the plurality of network devices utilize different hardware, firmware, and/or configuration data.

Instructions 230, when executed by a processing resource such as processing resource 222 can establish a connection with the plurality of network devices utilizing the captured configuration data. As described herein, the monitor device 204 can utilize the configuration data to establish a connection with each of the plurality of network devices. In some examples, establishing a connection with the plurality of network devices can include establishing a communication channel with the plurality of network devices. In some examples, the established connection can include a communication connection that allows the monitor device to instruct the plurality of network devices to perform the health checks and/or other network device specific functions.

In some examples, the monitor device 204 can utilize the established connection to alter settings or functions of the plurality of network devices. For example, the monitor device 204 can utilize the established connection to alter a storage location for log data of the plurality of network devices. In this example, the monitor device 204 can alter the storage location from a memory device of the network device to a database. In some examples, the connection can allow the monitor device to execute instructions stored on the plurality of network devices. For example, functions that are specific to a particular network device can be initiated for execution by the monitor device through the established connection. In some examples, the monitor device can utilize the established connection to alter settings of the network device through instructions that are stored on the network device.

In some examples, the established connection with the plurality of network devices can be a secured communication connection that can authorize the monitor device 204 to be an administrator for the plurality of network devices. As described herein, the monitor device 204 can utilize the configuration data of the plurality of network devices to establish a secure connection that allows the monitor device 204 to alter settings of the plurality of network devices. In this way, the monitor device 204 can be an administrator for a plurality of network devices that include different hardware, firmware, and/or features. In some examples, the monitor device can utilize the configuration data to instruct the plurality of network devices send log data to the memory resource (e.g., database, remote storage, etc.).

Instructions 232, when executed by a processing resource such as processing resource 222 can capture log data from the plurality of network device through the established connection. In some examples, the monitor device 204 can also utilize the established connection to receive and/or transfer the log data to a database (e.g., centralized database for a network, etc.). As described herein, the monitor device 204 can establish the connection with the plurality of network devices to alter settings of the plurality of network devices. In some examples, the altered settings implemented by the monitor device 204 can include altering a storage location of log data for the plurality of network devices from cache storage on the network device to a database. In some examples, the instructions 232 can include instructions to perform health checks on the plurality of network devices through the established connection. In some examples, a monitor device can be utilized to initiate and/or run network device specific instructions that initiates a health check for the corresponding network devices. In some examples, the health checks can include network availability checks, name resolution checks, and secure shell (SSH) key acknowledgment checks.

In some examples, the connection is established with each of the plurality of network devices based on a model and firmware type identified in the captured configuration data. As described herein, the configuration data can include information related to a corresponding network device. In some examples, the information can include a model and firmware type that is utilized by a particular network device. In these examples, the connection can be established with the particular network device based on this information.

In other examples, the monitor device 204 can be utilized to alter a format of the log data to be provided to the database. For example, the monitor device 204 can alter a format of the log data from the plurality of network devices to a uniform format that can be stored in the database. In this way, the database can include log data for the plurality of network devices that can be analyzed. In some examples, it can be difficult to analyze log data with different formats. Thus, the uniform format of the log data from the plurality of network devices can allow the monitor device 204 to analyze the log data for the network that includes the plurality of network devices. For example, the uniform format can allow the monitor device 204 to generate event tables, notifications, and/or other monitoring features for the network.

Instructions 234, when executed by a processing resource such as processing resource 222 can generate an event table for the network based on the captured log data. As described herein, the captured log data from the plurality of network devices can be updated or altered to a uniform format such that the monitor device 204 can more easily analyze the captured log data stored in the database. In some examples, the monitor device 204 can utilize the captured log data to generate an event table. As used herein, an event table can, for example, include information related to a particular event that has occurred on the network and/or a particular event that has occurred on a particular network device. In some examples, the event table can include timing information about the event, an event code that can describe the event, and/or other information that relates to the event (e.g., trial, event type, event code, properties of the event, time of event, duration of the event, etc.).

In some examples, the monitor device 204 can be utilized to generate notifications based on the log data received from the plurality of network devices. For example, the monitor device 204 can be utilized to analyze the log data from the database to generate notifications. In some examples, the notifications can be generated and sent to a user device to notify a user of the occurrence of a particular event. In some examples, the generated notifications can identify an event, a network device where the event occurred, and/or other information to notify the user of the occurrence of the event. In some examples, the log data is stored and archived to be searchable for a period of time. In these examples, the log data can be deleted from the database (e.g., cleaned up, etc.). In some examples, a monitor device can categorize the log data of the memory resource or database to provide a searchable database for the log data. That is, the monitor device can organize the log data such that search engines can be utilized to search for particular log data or particular events. In some examples, the monitor device can categorize the log data of the database based on the configuration data of a corresponding network device that sent the log data to the database. That is, the configuration data for a particular network device can be utilized when categorizing the log data for the particular network device. For example, the log data can include a portion of the configuration data to identify the particular network device from other network devices of the network.

In some examples, the monitor device 204 can be utilized to monitor a network with a plurality of network devices that utilize different hardware, firmware, and/or other features. In this way, the monitor device 204 can be utilized with an existing network that utilizes a plurality of different types of network devices and uniformly generate event tables and/or notifications for the entire network.

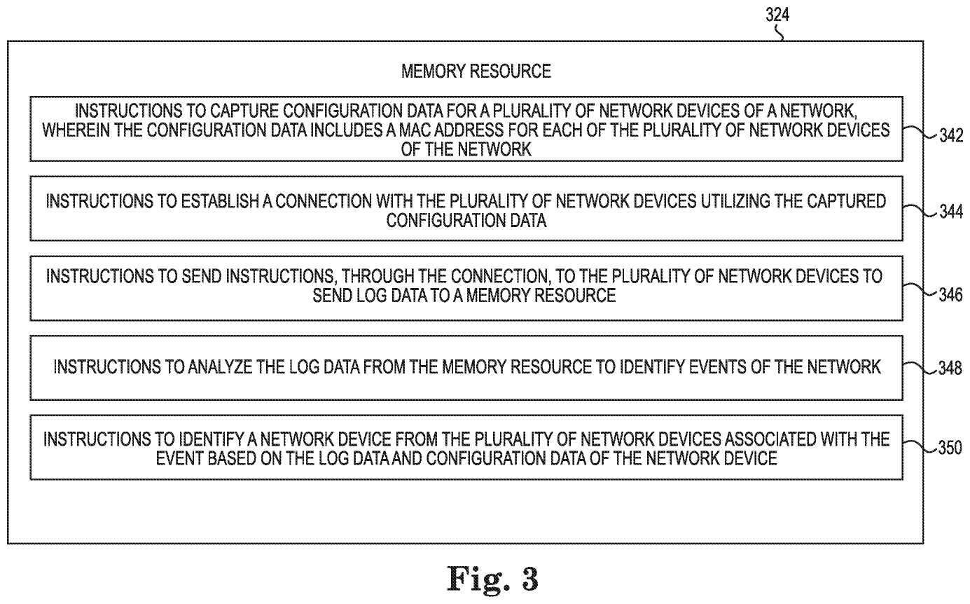

FIG. 3 is an example memory resource 324 for network device monitors including instructions executable by a processing resource consistent with the present disclosure. In some examples, the memory resource 324 can be utilized by a monitor device (e.g., monitor device 104 as referenced in FIG. 1, monitor device 204 as referenced in FIG. 2, etc.) A processing resource, as used herein, can include a number of processing resources capable of executing instructions stored by a memory resource such as memory resource 324. The instructions (e.g., machine-readable instructions (MRI)) can include instructions stored on the memory resource 324 and executable by the processing resource to implement a desired function (e.g., network device monitoring). The memory resource 324, as used herein, can include a number of memory components capable of storing non-transitory instructions that can be executed by processing resource. Memory resource 324 can be integrated in a single device or distributed across multiple devices.

Instructions 342, when executed by a processing resource can capture configuration data for a plurality of network devices of a network, wherein the configuration data includes a MAC address for each of the plurality of network devices of the network. As described herein, capturing the configuration data for the plurality of network devices can include sending a request for the configuration data to each of the plurality of network devices.

In some examples, the request for the configuration data can be different for each of the plurality of network devices. For example, the plurality of network devices can be different types of network devices that utilize different hardware, firmware, and/or other features. In this example, the plurality of network devices can be provided by different manufacturers and may utilize different instructions for retrieving the configuration data.

In some examples, the configuration data from the plurality of network devices can be utilized by a monitor device for collecting data (e.g., log data, etc.) from the plurality of network devices. That is, the configuration data received from the plurality of network devices can be utilized to access information from the plurality of network devices, alter settings of the plurality of network devices, and/or monitor log data from the plurality of network devices.

Instructions 344, when executed by a processing resource can establish a connection with the plurality of network devices utilizing the captured configuration data. As described herein, the configuration data received from the plurality of network devices can be utilized to establish a connection with each of the plurality of network devices even when the plurality of network devices include devices from different manufacturers and/or devices that utilize different hardware and/or firmware. In previous systems it can be difficult to monitor a network with a plurality of network devices with different hardware and/or firmware since the different network devices can have different settings and/or different commands for obtaining and storing log data.

In the present disclosure, the connection can be established to alter settings for the plurality of network devices. In some examples, the settings of the plurality of network devices can be altered to make each of the plurality of network devices perform in a similar way to more easily monitor the plurality of network devices. For example, each of the plurality of network devices can include settings for monitoring and storing log data. In this example, the monitor device can alter the settings for monitoring and storing the log data such that each of the plurality of network devices utilize a similar process for monitoring and storing the log data.

Instructions 346, when executed by a processing resource can send instructions, through the connection, to the plurality of network devices to send log data to a memory resource. In some examples, the established connection can allow the monitor device to have administrative access to the settings of the network device. As used herein, administrative access can, for example, include access to a device provided to a user or other device that allows the user or other device to make changes to the device as an administrator of the device.

In some examples, the monitor device can utilize the administrative access to send instructions to the plurality of network devices through the established connections with the plurality of network devices. In a specific example, the monitor device can send instructions to the network device that can be executed by a processing resource of the network device to alter the settings of the network device. In some examples, the settings to be altered can include altering the monitoring settings and/or storing settings of the log data for the plurality of network devices. For example, the instructions can be sent to the plurality of network devices such that the plurality of network devices can begin to send log data to a memory resource such as a database instead of storing the log data in a cache memory device of the network device. In this way, the plurality of network devices can each send corresponding log data to the memory resource such that the monitor device can analyze the log data from the memory resource.

Instructions 348, when executed by a processing resource can analyze the log data from the memory resource to identify events of the network. As described herein, the monitor device can provide instructions to the plurality of network devices to send the log data from the plurality of network devices to the memory resource (e.g., database, etc.). In other examples, the monitor device can provide instructions to the plurality of network devices such that the log data provided to the memory resource is in the same or similar format. For example, the monitor device can be utilized to send instructions to the plurality of network devices such that the plurality of network devices send uniformed or substantially uniformed log data to the memory resource.

As used herein, uniformed or substantially uniformed log data can be log data that is in the same or similar format with the same or similar information. In this way, the log data from a first network device can be compared or analyzed with a second network device even when the first network device and the second network device are different types of network devices or utilize different hardware or firmware. In addition, utilizing uniformed or substantially uniformed log data can allow the monitor device to monitor, generate tables, and/or generate notifications for the entire network even when the plurality of network devices are different network device types, such as network devices from different manufacturers.

In some examples, the monitor device can more easily analyze the log data from the memory resource (e.g., database) when the log data is in a uniformed or substantially uniformed format. For example, the monitor device can utilize the log data to identify events that have occurred on the network. In this example, the uniformed or substantially uniformed log data can make it relatively easier to identify events or inconsistencies in the log data that could be an indication of the event.

Instructions 350, when executed by a processing resource can identify a network device from the plurality of network devices associated with the event based on the log data and configuration data of the network device. In some examples, the monitor device can be utilized to identify the network device from the plurality of network devices where the event occurred. In this way, a notification can be generated with the network device information. In some examples, the instructions 350 can include instructions to send a notification when the network device is identified.

In some examples, the notification can be customized for a particular user or particular group of users. In these examples, the particular user or particular group of users can be based on the type of network device where the event occurred. For example, a first user may work with a first type of network device and a second user may work with a second type of network device. In this example, the type of network device associated with the event can be identified and a notification can be generated for a corresponding user based on the type of network device. In other examples, a first user may work with a first type of event and a second user may work with a second type of event. In these examples, the notification can be based on the type of event that has occurred and customized for a corresponding user that works with the type of event.

In some examples, the monitor device can utilize the log data and configuration data of the network device to identify the network device associated with the event. For example, the log data can include a data related to a particular event and/or information related to the network device such as information from the configuration data to identify the network device that has generated the log data. In this way, the monitor device can be utilized to identify events and corresponding network devices for a network with a plurality of network devices that utilize different hardware and/or firmware.

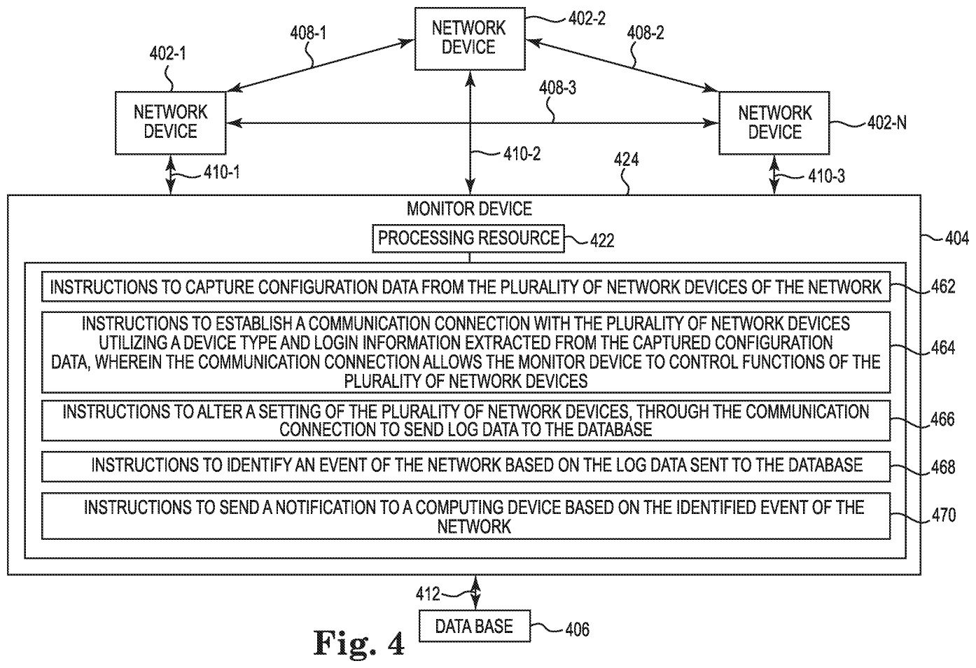

FIG. 4 is an example system 400 for network device monitors consistent with the present disclosure. In some examples, the system 400 can be the same or similar system as system 100 referenced in FIG. 1. For example, the system 400 can be a network that can be utilized to provide a communication channel between computing devices. In some examples, the system 400 can include a plurality of network devices 402-1, 402-2, 402-N. In some examples, the plurality of network devices 402-1, 402-2, 402-N can include communication channels 408-1, 408-2, 408-3 to send and receive messages (e.g., data packets, etc.) between the plurality of network devices 402-1, 402-2, 402-N and/or other computing devices coupled to the system 400. As described herein, the plurality of network devices 402-1, 402-2, 402-N can include different types of network devices that have different manufacturers, different types of hardware, and/or different types of firmware.

In some examples, the system 400 can include a monitor device 404. The monitor device 404 can be a computing device that is communicatively coupled to the system 400. For example, the monitor device 404 can include a processing resource 422, a memory resource 424 that stores instructions 462, 464, 466, 468, 470. In some examples, the monitor device 404 can establish a communication channel 410-1, 410-2, 410-3 or communication connection with each of the plurality of network devices 402-1, 402-2, 402-N. In some examples, the monitor device 404 can be communicatively coupled to the database 406 through a communication channel 412. In some examples, the database 406 can include a memory resource to store the log data from the plurality of network devices 402-1, 402-2, 402-N. In some examples, the monitor device 404 can generate an event table within the database 406 from the log data provided to the database 406 from the plurality of network devices 402-1, 402-2, 402-N.

A monitor device 404, as used herein includes a device (e.g., physical device) used for communication and interaction between network devices on a computer network. Network devices can mediate data in a computer network. Example network devices include switching devices (also known as “switches”), routers, router/switching device combinations, models, access points, gateways, networking cables, network interface controllers, and hubs, among others. In some instances, monitor device 404 can be or include a controller. Monitor device 404 can be a combination of hardware and instructions for network device monitoring. The hardware, for example can include processing resource 422 and/or a memory resource 424 (e.g., MRM, computer-readable medium (CRM), data store, etc.).

Processing resource 422, as used herein, can include a number of processing resources capable of executing instructions stored by a memory resource 424. The instructions (e.g., machine-readable instructions (MRI)) can include instructions stored on the memory resource 424 and executable by the processing resource 422 to implement a desired function (e.g., network device monitoring). The memory resource 424, as used herein, can include a number of memory components capable of storing non-transitory instructions that can be executed by processing resource 422. Memory resource 424 can be integrated in a single device or distributed across multiple devices. Further, memory resource 424 can be fully or partially integrated in the same device as processing resource 422 or it can be separate but accessible to that device and processing resource 422. Thus, it is noted that the monitor device 404 can be implemented on an electronic device and/or a collection of electronic devices, among other possibilities.

The memory resource 424 can be in communication with the processing resource 422 via a communication link (e.g., path). The communication link can be local or remote to an electronic device associated with the processing resource 422. The memory resource 422 includes instructions 462, 464, 466, 468, 470. The memory resource 424 can include more or fewer instructions than illustrated to perform the various functions described herein. In some examples, instructions (e.g., software, firmware, etc.) 462, 464, 466, 468, 470 can be downloaded and stored in memory resource 424 (e.g., MRM) as well as a hard-wired program (e.g., logic), among other possibilities.

Instructions 462, when executed by a processing resource such as processing resource 422 can capture configuration data from the plurality of network devices 402-1, 402-2, 402-N of the network. As described herein, capturing the configuration data from the plurality of network devices 402-1, 402-2, 402-N can include sending a request to the plurality of network devices 402-1, 402-2, 402-N. in some examples, the configuration data can include information related to the plurality of network devices 402-1, 402-2, 402-N such as, but not limited to: a MAC address, an IP address, a make or model number, a firmware type, device type, and/or other information related to the functionality of the plurality of network devices 402-1, 402-2, 402-N.

Instructions 464, when executed by a processing resource such as processing resource 422 can establish a communication connection (e.g., communication channels 410-1, 410-2, 410-3, etc.) with the plurality of network devices 402-1, 402-2, 402-N utilizing a device type and login information extracted from the captured configuration data, wherein the communication connection allows the monitor device 404 to control functions of the plurality of network devices 402-1, 402-2, 402-N. As described herein, the configuration data can be utilized to establish a secure connection and/or an administrative connection with the plurality of network devices 402-1, 402-2, 402-N. In some examples, the configuration data can include login information that can be utilized to login to otherwise restricted features of the plurality of network devices 402-1, 402-2, 402-N.

In some examples, the established communication connection can be utilized to send instructions to the plurality of network devices 402-1, 402-2, 402-N that can alter settings or functions of the plurality of network devices 402-1, 402-2, 402-N. For example, the monitor device 404 can send instructions to network device 402-1 through a communication channel 410-1. In this example, the monitor device 404 can alter settings of the network device 402-1 and/or send instructions to the network device 402-1 to have the network device 402-1 perform a particular function (e.g., reset, alter a setting related to log data, etc.).

In some examples, the monitor device 404 can send instructions that can be executed by the plurality of network devices 402-1, 402-2, 402-N. For example, the monitor device 404 can send instructions to network device 402-2 through communication channel 410-2. In this example, the instructions can be received by the network device 402-2 and executed by a processing resource of the network device 402-2 to perform a particular function. In these examples, the configuration data can be utilized to generate the instructions that are sent to the corresponding network device of the plurality of network devices 402-1, 402-2, 402-N.

Instructions 466, when executed by a processing resource such as processing resource 422 can alter a setting of the plurality of network devices 402-1, 402-2, 402-N, through the communication connection to send log data to the database 406. As described herein, the monitor device 404 can utilize a corresponding communication channel 410-1, 410-2, 410-3 to alter settings of the plurality of network devices 402-1, 402-2, 402-N. In some examples, the monitor device 404 can utilize a corresponding communication channel 410-1, 410-2, 410-3 to alter settings of how the plurality of network devices 402-1, 402-2, 402-N generate and store log data.

For example, the monitor device 404 can alter the format of log data generated by network device 402-1. In this example, the monitor device 404 can alter the format of the log data for network device 402-1 such that the format and information within the log data is uniform or substantially uniform with log data generated by other network devices of the network (e.g., 402-2, 402-N, etc.). Furthermore, in this example, the monitor device 404 can alter the storage location for the log data from cache memory on the network device 402-1 to the database 406.

Instructions 468, when executed by a processing resource such as processing resource 422 can identify an event of the network based on the log data sent to the database 406. In some examples, the monitor device 404 can identify an event based on the log data stored in the database 406. In some examples, the log data stored in the database 406 can be analyzed by the monitor device 404 to identify particular events or issues with the network. In some examples, the log data can be uniformed or substantially uniformed through the instructions sent to the plurality of network devices 402-1, 402-2, 402-N.

Instructions 470, when executed by a processing resource such as processing resource 422 can send a notification to a computing device based on the identified event of the network. In some examples, a notification can be generated based on the type of event and/or based on the network device where the event occurred. In some examples, the notification can be generated based on a user that is to receive the notification. For example, the type of event and/or the type of network device can be utilized by the monitor device 404 to determine a user device or user to send the notification.

The system 400 can be utilized to monitor a network with a plurality of network devices 402-1, 402-2, 402-N that utilize different hardware and/or firmware. In some examples, the monitor device 404 can be utilized to alter settings of the plurality of network devices 402-1, 402-2, 402-N to generate uniform or substantially uniform log data and store the log data in a centralized location such as the database 406. In this way, the monitor device 404 can be utilized to analyze the log data to identify particular events and/or generate particular notifications based on the identified events.

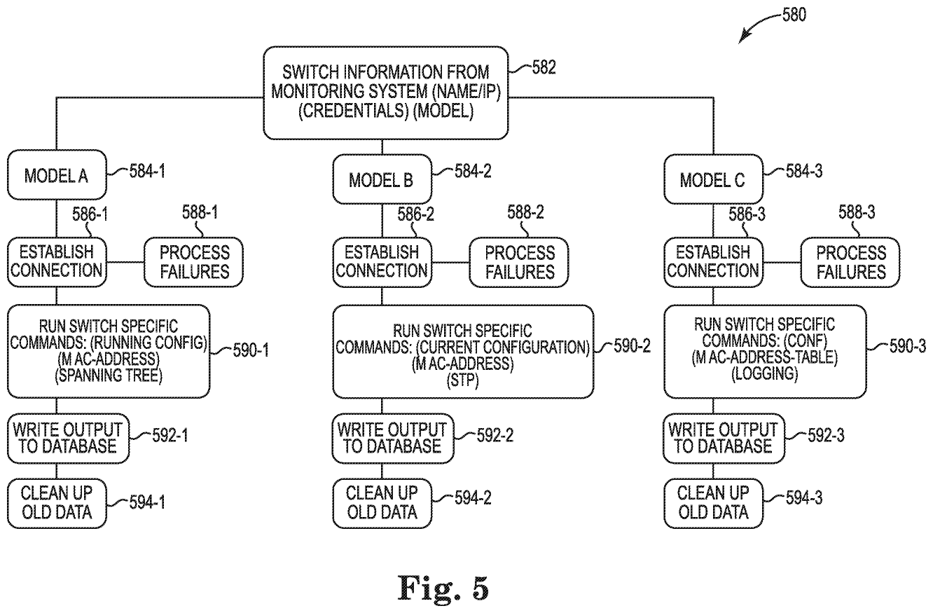

FIG. 5 is an example flow diagram 580 for network device monitors consistent with the present disclosure. In some examples, the flow diagram 580 can represent a method for monitoring network devices of a network. In some examples, the flow diagram 580 can be instructions that can be stored on a memory resource that are executable by a processing resource to perform the method.

In some examples, the flow diagram 580 can start at 582 by obtaining or capturing network device information such as switch information from a monitoring system. In some examples, the flow diagram 580 can move to one of a plurality of models 584-1, 584-2, 584-3 based on a type of a network device determined from the network device information. For example, a first type of network device can correspond to model A 584-1 and a second type of network device can correspond to model B 584-2.

In some examples, the flow diagram 580 can illustrate different models 584-1, 584-2, 584-3 that can be utilized for different network device types. In some examples, model A 584-1 can be utilized for a first type of network device. For the first type of network device, the flow diagram 580 can move to element 586-1 to establish a connection with the first type of network device. In some examples, establishing the connection can include process failures 588-1. For example, the process failures 588-1 can be failures to establish the connection 586-1 with the first type of network device.

When a connection is established the flow diagram 580 can move to 590-1 to run switch specific commands for the first type of network device. For example, the first type of network device can be a network switch that utilizes specific commands or instructions for the network switch that may not work or be applicable for a second type of network device.

In some examples, the flow diagram 580 can move to 592-2 to instruct the first type of network device to provide output data from the first type of network device to a database. As described herein, the switch specific commands that are performed at 590-1 can allow a monitor device to instruct the network device to send log data or other types of data to the monitor device and/or to the database instead of or in addition to storing the data to a cache memory on the network device.

In some examples, the database can be utilized to store the log data or other types of data from a plurality of different network devices for a particular period of time. In some examples, the flow diagram 580 can move to 594-1 to clean up old data or data that has exceeded the particular time period of time.

In a similar way to model A 584-1, model B 584-2 can be designated for network devices, such as switches, of a second type. Model B 584-2 can establish a connection with the second type of network device at 586-2 and any process failures can happen at 588-2 while trying to establish a connection with the second type of network device. In addition, model B 584-2 can move to 590-2 to run switch specific commands for the second type of network device. As described herein, the switch specific commands can be specific for the second type of network device and may not work or execute on the first type of network device. Model B 584-2 can then move to write output data to the database at 592-2 and clean up old data from the database at 594-2.

In a similar way to model A 584-1 and model B 584-2, model C 584-3 can be designated for network devices, such as switches, of a third type. Model C 584-3 can establish a connection with the third type of network device at 586-3 and any process failures can happen at 588-3 while trying to establish a connection with the third type of network device. In addition, model C 584-3 can move to 590-3 to run switch specific commands for the third type of network device. As described herein, the switch specific commands can be specific for the third type of network device and may not work or execute on the first type of network device or the second type of network device. Model C 584-3 can then move to write output data to the database at 592-3 and clean up old data from the database at 594-3.

As described herein, the flow diagram 580 can be performed by a monitor device (e.g., monitor device 104, etc.) to monitor a plurality of network devices that include different types of network devices. For example, the plurality of network devices can include a first type of network device that utilizes device specific commands that are different than a second type of network device. In this way, log data, event data, and/or other types of data can be monitored, collected, and/or analyzed from a plurality of different network device types.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure and should not be taken in a limiting sense. Further, as used herein, “a number of” an element and/or feature can refer to any number of such elements and/or features.

What is claimed:

1. A monitor device comprising a processing resource in communication with a memory resource including instructions executable by the processing resource to:
capture configuration data for a plurality of network devices of a network;
establish a connection with the plurality of network devices utilizing the captured configuration data;
capture log data from the plurality of network device through the established connection; and
generate an event table for the network based on the captured log data.

2. The monitor device of claim 1, wherein the configuration data includes a domain name system (DNS) name for the plurality of network devices, a model for the plurality of network devices, a firmware for the plurality of network devices, and credentials for the plurality of network devices.

3. The monitor device of claim 1, wherein the instructions to capture log data includes instructions to perform health checks on the plurality of network devices through the established connection.

4. The monitor device of claim 3, wherein the established connection is a communication connection that allows the monitor device to instruct the plurality of network devices to perform the health checks.

5. The monitor device of claim 3, wherein the health checks include network availability checks, name resolution checks, and secure shell (SSH) key acknowledgment checks.

6. The monitor device of claim 1, wherein the log data is stored and archived to be searchable for a period of time.

7. The monitor device of claim 1, wherein the connection allows the monitor device to execute instructions stored on the plurality of network devices.

8. A non-transitory computer-readable medium storing instructions executable by the processing resource to:
capture configuration data for a plurality of network devices of a network, wherein the configuration data includes a MAC address for each of the plurality of network devices of the network;
establish a connection with the plurality of network devices utilizing the captured configuration data;
send instructions, through the connection, to the plurality of network devices to send log data to a memory resource;
analyze the log data from the memory resource to identify events of the network; and
identify a network device from the plurality of network devices associated with the event based on the log data and configuration data of the network device.

9. The medium of claim 8, wherein the instructions to send instructions to the plurality of network devices includes utilizing the configuration data to instruct the plurality of network devices send log data to the memory resource.

10. The medium of claim 8, comprising the instructions executable to categorize the log data of the memory resource to provide a searchable database for the log data.

11. The medium of claim 8, wherein the connection is established with each of the plurality of network devices based on a model and firmware type identified in the captured configuration data.

12. The medium of claim 8, comprising the instructions executable to send a notification when the network device is identified.

13. A system comprising:
a plurality of network devices of a network;
a database communicatively coupled to the network; and
a monitor device communicatively coupled to the database, the monitor device comprising a processing resource in communication with a memory resource including instructions executable by the processing resource to:
capture configuration data from the plurality of network devices of the network;
establish a communication connection with the plurality of network devices utilizing a device type and login information extracted from the captured configuration data, wherein the communication connection allows the monitor device to control functions of the plurality of network devices;
alter a setting of the plurality of network devices, through the communication connection to send log data to the database;
identify an event of the network based on the log data sent to the database; and
send a notification to a computing device based on the identified event of the network.

14. The system of claim 13, wherein the notification includes information about a network device from the plurality of network devices where the event occurred.

15. The system of claim 13, wherein the monitor device includes instructions to categorize the log data of the database based on the configuration data of a corresponding network device that sent the log data to the database.

16. The system of claim 13, wherein the communication connection allows the monitor device to execute network device specific instructions.

17. The system of claim 16, wherein the network device specific instructions are instructions stored on the network device.

18. The system of claim 13, wherein the notification is sent to a user device based on a network device from the plurality of network devices where the event occurred.

19. The system of claim 13, wherein the monitor device includes instructions to alter a format of the log data to a uniform format.

20. The system of claim 13, wherein the monitor device includes instructions to or identify a process for altering settings of each of the plurality of network devices based on the configuration data.
